(19) United States
(12) Patent Application Publication
(10) Pub. No.: US 2003/0216982 A1
(43) Pub. Date: Nov. 20, 2003

(54) Messaging gateway for incentivizing collaboration

(76) Inventors: Tyler Close, Sandy Hill (AI); Susannah Butler, Sandy Hill (AI)

Correspondence Address: Tyler Close, 8345 NW 66TH Street, Box 4128, Miami, FL, 33166-2626, US

(21) Appl. No.: 10/146,942

(22) Filed: May 17, 2002

(51) Int. Cl. G06F 17/60

(52) U.S. Cl. 705/35

(57) ABSTRACT

A messaging gateway facilitates collaboration among groups of loosely-related people. Users send collaboration requests along relationship chains in search of someone who can fulfill the request. Relationship chains are made up of links of users. Users who forward or respond to the request can receive payment. The messaging gateway encourages risk management by providing payment statistics covering past transactions to each message recipient. The messaging gateway can also add links to previously fulfilled collaboration requests or other information that will help the recipient fulfill the request. The messaging gateway can log payments sent to a user. The messaging gateway generates payment demands and adds them to a reply message to facilitate payment. The messaging gateway may also initiate payments to users. If the recipient so indicates, the messaging gateway generates a parent message from a child message.

### BACKGROUND OF THE INVENTION

This collaborative messaging gateway invention relates to the field of groupware; more specifically, it relates to systems that encourage collaboration among groups of loosely-related people.

Messaging networks allow groups of people to exchange electronic messages. Theoretically, this message-passing facility should encourage development of new working relationships. Current systems for using these messaging networks often fail to consistently encourage ad hoc collaboration among strangers.

A messaging network member should be able to engage in productive exchange with another member. A successful exchange requires identifying a potential collaborator and providing an incentive to him or her to collaborate. The existing prior art concentrates more on identifying potential collaborators than on providing incentives for collaboration. Both elements are necessary for successful collaboration. The collaborative messaging gateway disclosed here provides a mechanism to improve both the identification and incentivizing steps of the collaboration task.

Mailing Lists and Bulletin Boards

Mailing lists and bulletin boards address the issue of finding collaborators; they attract people with similar interests to one place. However, they do not successfully incentivize members to collaborate with one another. In some situations, these forums even offer disincentives to participation.

Mailing lists and bulletin boards allow users to pose a question to other users, either via electronic mail (“email”) or on a web page. Despite differing interfaces, the systems are nearly identical in function.

Mailing lists and bulletin boards make requesting collaboration easy. A collaboration requestor can post a message stating his requirements. However, both forums are unaccommodating to members who might respond to collaboration requests (“would-be collaborators”). Would-be collaborators must sift through requests to find ones to which they can respond. This situation often leads to the classic “tragedy of the commons,” in which everyone wishes to take (ask for collaborators) but nobody wishes to give (collaborate). The list or board swells with unanswered requests.

Requests are so easy to post that similar ones appear over and over again. Ease of posting also leads to “flames” or “trolls” (inflammatory postings) and chatty, off-topic posts. Both types of posts may bore or annoy more knowledgeable members, increasing their attrition rate. Boards and lists can self destruct because the valuable members tire of them and depart, leaving remaining members who are solely novices or information-seekers.

Moderators can help keep the posts appropriate and on-topic, but many boards are not moderated due to the cost of hiring a moderator. Moderating is a hard job, as moderators must read everything, get along with the members, and enforce the rules. Everybody on the list must conform to the moderator's point of view, which restricts the posts, possibly making the forum less useful. Additionally, moderating does not solve the problems of recurring posts or the tragedy of the commons. Boards and lists fail to motivate knowledgeable members to collaborate.

The only incentive to collaborate on a board or list is reputation-building. If a board or list is not functioning as a community, due to the tragedy of the commons, building a reputation is meaningless. By its very nature, a board or list tends to undermine what little incentive it offers to would-be collaborators.

Further, a board or list offers disincentives to collaborators. If a collaborator posts a response to a request, then her email address is publicly viewable. Public email addresses are often targets for “spam” (unsolicited commercial email).

Expert Databases

Expert databases are another solution to the problem of finding collaborators. Most expert database systems also seek to incentivize experts to collaborate via payment in some form. However, expert databases do not offer an efficient solution to the complex problem of matching collaboration requests to experts. Nor do expert databases suggest an effective system for transaction risk management.

Expert database services match collaboration requesters to experts in the relevant field. Generally the collaboration requestor sends a request to the system. The request is matched, either via software or an actual person, to an expert who responds. Sometimes money is exchanged. These database services are similar to moderated lists or boards. However, instead of merely filtering the requests seen by all potential recipients, the moderator carries the additional burden of directing the request to a specific would-be collaborator.

Mailing lists and bulletin boards require a would-be collaborator to sift through requests to find ones she can address. An expert database system takes this burden off the would-be collaborator, creating a “headhunting” job. The job can be filled by a dedicated research team, a piece of software, or simply passed on to the person requesting collaboration.

The most obvious practice for fulfilling the headhunting job is to use a researcher or team of researchers. The team can read requests, evaluate what kind of expert can collaborate with the requestor, and find the expert. The team will first search its own database of experts for a suitable match. If a likely expert is not in the database, researchers could consult university directories to find someone in a specific subject area and then contact that person. This type of legwork is very costly, inefficient, and reliant on the researchers' knowledge of resources. In general, the logistics of knowing the abilities of all experts and efficiently routing requests to them are complex and expensive. The cost is prohibitive in most collaborative situations; a software-based solution might be more appropriate.

Jakob Nielsen realizes that the headhunting job is impossible for a human to do. U.S. Pat. No. 5,948,054 to Nielsen, Sep. 7, 1999, takes the software approach to the logistics of matching an expert to a collaboration request. This patent posits a software headhunter that uses natural language to interpret a request and match it to an expert in a database. Given the state of the art of natural language technology, this software cannot be implemented.

Natural language technology is not yet to the point where parsers can truly differentiate among the subtleties of human speech. They may be of some use in a very restricted situation, but not over as broad a context as all possible requests for collaboration. Additionally, current implementations of natural language searching require extensive manpower to keep the system up-to-date (Oreskovic, A. [Apr. 24, 2000]. The Language Barrier. The Industry Standard. http://www.thestandard.com/article/0, 1902,14040,00.html?body_page=1, page 3. [Apr. 11, 2000].). Given the difficulties of system-based expert matching, other people have tried to solve the headhunting problem by pushing it out of the system.

Keen.com solves the headhunting problem by passing off the expertise locating task to its users. Users locate an expert by browsing or searching the Keen.com database of experts. Keen.com is essentially a targeted search engine, allowing users to search for resumes. Requiring a user to find an expert presents some problems. A directory that covers every topic on which a human could wish to collaborate would be unwieldy. A searchable database is a possible solution, but humans have a difficult time developing search queries.

Expressing a complex idea via keywords, as most database searching requires, is difficult for people (Lu, F., et al. Enhancing Internet Search Engines to Achieve Concept-based Retrieval. http://www.osti.gov/inforum99/papers/csss.html#n2 [Apr. 11, 2002].). Forrester Research estimates that 92% of online searches do not yield relevant results (Oreskovic). This lack of results can be attributed in part to bad search queries. Failure to locate relevant results also stems from the inability of any search engine to capture 100% of all online information. This effect is exacerbated in Keen.com's case, as they need to recruit experts into their database before users can search for the experts. Recruiting experts on every subject possible is an enormous task.

The difficulty of matching experts to requests is not the only problem that expert databases face. The basic purpose of an expert database is to directly connect two strangers. Matching strangers for a one-time transaction, such as the answering of a question, inherently leads to high transaction risk. Strangers have no basis on which to trust each other to honor an agreement. Specifically, the risks are that the answer is not worth the price paid or that the price is never paid. The risk can be absorbed by either the requester, the collaborator, or the system. If the requestor pays up-front for the collaboration, he risks the collaborator returning a worthless response. If the collaborator responds before payment, she risks not being paid. Otherwise the system must act as a broker, receiving the payment and evaluating the answer, or making good any non-payment. A system-as-broker solution is very expensive and very work-intensive.

Referral-Based Searching

Referral-based searching systems use email to locate potential collaborators. Currently, these systems are not successfully incentivizing the finding of collaborators. Further, they fail to offer incentives to a would-be collaborator.

A time-honored way of finding answers has always been to ask one's friends or acquaintances. Email software handily supports this practice through the ability to “forward,” or send copies of, emails. In an ideal world, a question sender could send his question in an email to friends. If the recipients could not answer it, they would forward it on. The forwarding would continue until the message reached someone who could answer it. However, in the real world, no incentives exist for this process to come to fruition. People will not be willing to forward a lot of email to their friends if no one will gain.

U.S. Pat. No. 5,619,648 to Canale, Apr. 8, 1997, deals with the lack of motivation to forward messages. It posits automating the forwarding process, making it invisible and effortless. The patent discusses a system that can be used for expertise locating. The system allows a user to associate keywords with an email. Emails are sent to recipients based on their email addresses as well as the presence of a keyword associated with each address. If a specified recipient does not have that keyword, she never sees the email. The system software searches her email address book, looking for addresses that do have this keyword. The system forwards the email to these addresses.

Using automatic forwarding in this way can have dangerous consequences for personal relationships. For instance, Bob and Carol are correspondents. Carol has the keyword “book” associated with her email address. An advertiser gets ahold of Bob's email address, and sends an unsolicited email (spam) to Bob. The spam email specifies the keyword “book.” Bob does not receive the email, but it gets automatically forwarded to Carol. Bob has unwittingly directed spam to Carol. Most people dislike spam, as evidenced by the number and popularity of anti-spam software programs. Sending spam to one's close friends is generally not well-tolerated, and leads to interpersonal tension. Even if these automatic forwards were acceptable, the invention fails to motivate people to respond to the forwarded email.

U.S. Pat. No. 5,619,648 does not solve the problem of providing incentives for someone to collaborate. If a would-be collaborator gets a request from someone, why should she answer it? If the question has been forwarded through many people, the recipient may not even know the writer. She has some incentive to help a friend, to continue the good relationship, but very little to help a stranger. This lack of incentive becomes more troublesome as the complexity of the collaboration request increases.

Paid Email

Paid email is an attempt to convince people to collaborate by sending them money. An email containing a payment is sent to a recipient. The payment is meant as an incentive for recipients to fulfill the sender's request. Prepaying the recipient, though, does not actually encourage him to take action. Paid email systems shift the transaction risk from the message recipient to the sender. Within the paid email system, the sender has no recourse if he receives an unsatisfactory reply or no reply.

From the sender's point of view, paid email is a risky way to initiate collaboration. Sending a stranger or even an acquaintance a prepaid request does not guarantee a quality response, nor any response at all. The recipient has already received an award and thus has no further motivation to act. The sender has spent the money and risks receiving nothing in return.

Paid email systems give the question sender no way to express dissatisfaction at a response. The system does not offer a feedback mechanism. The root of the problem lies in the money being paid up-front; the sender has no way to rescind payment to show disapproval. The only route open to a displeased sender is to cease dealing with the recipient.

A method of using communication networks that encourages collaboration among users is needed. The method must provide a way to identify potential collaborators and incentivize them to participate. The method must also provide a way to manage and reduce transaction risk; a user must be able to determine the transaction risk of working with a particular collaborator.

### BRIEF SUMMARY OF THE INVENTION

The present messaging gateway invention facilitates collaboration among groups of loosely-related people. The invention encourages users to form new relationship chains that enable collaboration and management of transaction risk. The links of a relationship chain are pairs of members that know one another. Collaboration relies on the relationship chains because they link previously unknown users to each other through existing relationships. Information flows along these chains; members gain knowledge or services from new resources without the vagaries of transacting with strangers. Users have social incentives to help one another; in the preferred embodiment, the messaging gateway invention further encourages collaboration through a financial incentive mechanism.

To offer a financial incentive to a message recipient, a message sender adds an offer price to a collaboration request. A price does not have to be a monetary amount; “price” in this invention means an amount of anything of value. When the sender receives a reply, he chooses to either pay or not pay the offer price. His choice is based on the quality of the reply. In this sense, the payment acts as a feedback mechanism. If a sender is unhappy with an answer, he can withhold payment. This mechanism pushes the transaction risk onto a collaborator. The messaging gateway helps the collaborator manage her risk via payment statistics.

The messaging gateway supports relationship chains by providing users with payment statistics on all parties with whom they transact. Payment statistics quantify the transaction risk in dealing with a specific sender. The payment statistics keep track of how often the sender makes good on his promises to pay. The payment statistics give users a basis on which to determine if collaborating with someone might be beneficial. Payment statistics aid in creating collaboration; users act in their own interests and forward or answer collaboration requests when they think they will benefit. The payment statistics encourage users to interact with known parties, on whom they have statistical data.

The preferred embodiment of the collaborative messaging gateway is a question-and-answer service. The service allows users to message other users with a price and a collaboration request, or “question.” If a recipient can answer the question, she can receive payment of the full price. If she cannot answer the question, she can forward the message to another user. If the question is answered and paid for, the answerer plus the message forwarders will all receive portions of the price. An example of the question-and-answer service in use provides an overview of the system.

Person A sends an email, containing a question, to Person B. The email has a price, Price A, associated with it. Person B cannot answer the question, but he thinks Person C can. Person B is motivated to help Person A, because Person A is in his social sphere. He is further motivated by the chance to receive a “finder's fee” from forwarding the email. In the preferred embodiment, Person B can decide on a new price for the answer, Price B. He replaces Price A with Price B in the email and forwards it to Person C. The finder's fee for Person B is the difference between Prices A and B.

Person C reads the email. She can answer the question and accepts Price B as fair. She can send an answer back to Person B. Person C need not know about Person A. She need only know of Person B, with whom she already has a relationship. In fact, Person C may not even know that the question originated with a third party, as the email comes directly from Person B. Before answering, Person C will decide whether or not she can expect Person B to pay her.

To assist recipients in determining whether to trust a sender to pay for an answer, the messaging gateway keeps payment statistics on every transaction. In the preferred embodiment, the messaging gateway inserts payment statistics into the question email. In the email, Person C can see payment statistics quoting how often Person B has paid her for an answer. If the payment statistics are favorable, Person C feels comfortable taking the time to answer Person B's question. She trusts him to honor the agreement and pay her. Had the question email come directly from Person A, Person C would have no reason to believe Person A would pay. Person A and Person C have no prior relationship, and therefore Person C does not have payment statistics on Person A. Thus, Person C may not have sent an answer. Person B went through the same reasoning concerning Person A before forwarding the email.

Person B receives Person C's answer, which he sends on to Person A. Person A evaluates the answer and determines whether it is worth Price A. If so, she initiates a payment to Person B's account. Person C is paid Price B from Person B's account, leaving Person B with his finder's fee.

Person A and Person C may be unknown to each other, but they are connected through a relationship chain. The forwarding of the question email creates a new relationship chain, which may be reused in the future. If the question was answered well and Person A paid in a timely manner, all parties are satisfied. In the future, Person A and Person B will feel comfortable working together, as will Person B and Person C. The chain from Person A to Person C may be used again.

If Person A had received an answer but decided not to pay, then the chain would have weakened and possibly broken. Person B would feel slighted, both on a personal level and a financial one. In his next dealing with Person A, Person B would take this slight into account. The payment statistics between Person A and Person B would reflect Person A's decreasing rate of payment. At some point, Person B might decide that Person A is not a good risk. The non-payment would propagate up the chain, as well, since Person B probably would not pay out-of-pocket to Person C. Person B's payment rate, reflected in Person C's payment statistics, would drop. However, Person B may be directing lots of questions, from many different sources, to Person C. If Person B usually collects on the questions, Person C usually gets paid. One non-payment from Person A would probably not make enough of a dent in Person B's payment rate to Person C. Obviously, each link in a chain will have a different tolerance for non-payment.

### OBJECTS AND ADVANTAGES

One object of the present messaging gateway invention is to make finding a collaborator easy, efficient, and successful. A user simply sends out a message to an acquaintance. Each recipient will forward the message in turn until someone can answer it. Each recipient of a message acts as a moderator, deciding which acquaintance might have the required expertise to respond to the message. From this standpoint, the system works very efficiently as work is spread out over all the participants; no single source, human or software, has to know all the available experts. Finding collaborators is not limited to the experts listed in a database. As long as a message is continually forwarded, a collaborator can be found. Messages will be continually forwarded, because the system incentivizes forwarding through finder's fees.

Once a collaborator is found, he is likely to answer the collaboration request. The collaborator receives the request from a friend, whom he is more likely to help than a stranger. The collaborator also has the chance to receive a fee for his answer. He can determine whether he is likely to be paid the fee by evaluating his transaction risk.

Another object of the messaging gateway invention is to provide a framework for managing transaction risk. In each member transaction, the collaboration requestor risks paying for unsatisfactory results, while the collaborator risks non-payment for his efforts. The messaging gateway keeps track of every transaction between pairs of message senders and recipients. The messaging gateway notes whether collaboration occurred and whether a payment was sent. Each time a recipient receives a collaboration request, she accesses payment statistics about her past dealings with the sender. Using the statistics, she can determine if forwarding or replying to a request is likely to result in payment. The payment statistics help a pair of users build a relationship and encourage them to work together in the future; users can better assess risk by dealing with known quantities. The building of relationships between users also lowers transaction risk. Classic game theory teaches that repetition in games means that participants are more likely to cooperate. (Levine, D. What is Game Theory? http://levine.sscnet.ucla.edu/general/whatis.htm [Apr. 14, 2002].). Users who know each other are more likely to honor payment promises and to provide quality collaboration.

Another object of the messaging gateway is to create a messaging network in which inappropriate messages are efficiently filtered out. Movement of messages along relationship chains means that each member filters the messages she sees. If a recipient receives spam, an offensive message, or another type of inappropriate message, she can simply choose not to forward it. She is unlikely to forward inappropriate messages as the message might hurt her relationship with other members. Thus the traffic of useless messages is greatly decreased.

Another object of the invention is to reduce the flow of redundant information to participants. That the ease of use will probably lead to the same requests sent over and over again is not a disincentive. Since the system is distributed, collaboration requests do not end up in a central repository, as in the prior art. Recipients filter questions by deciding to whom to send them. If the same collaboration request does go through a specific relationship chain routinely, then users along the relationship chain will learn the answer. Eventually, they will start to answer the questions themselves to earn the answer fee. They are shortening the relationship chain, preventing collaborators further up the relationship chain from having to deal with the duplicate collaboration requests.

Other objects and advantages of the messaging gateway will become apparent from a consideration of the ensuing description and drawings.

### BRIEF DESCRIPTION OF THE DRAWINGS

FIG. 1 is a block diagram of a question-and-answer system based on the messaging gateway.

FIG. 1a is a block diagram of the messaging gateway.

FIG. 2a illustrates the preferred format for a question email.

FIG. 2b illustrates the preferred format for a question email after the recipient's messaging gateway has added payment statistics.

FIG. 2c illustrates the preferred format for an outgoing answer email before the recipient's messaging gateway processes it.

FIG. 2d illustrates the preferred format for an outgoing answer email after the recipient's messaging gateway processes it.

FIG. 2e illustrates the preferred format for a refusal email.

FIG. 2f illustrates the preferred format for a forward email.

FIG. 3 is a flowchart illustrating the process of creating a question email.

FIG. 4 is a flowchart illustrating the process a messaging gateway carries out to process an outgoing email from the mail user agent.

FIG. 4a is a flowchart illustrating the process a messaging gateway carries out to add a payment demand to an outgoing email.

FIG. 5 is a diagram illustrating the preferred structure for a database record that maps a Message-ID message identifier to a message and a status.

FIG. 6 is a flowchart illustrating the process a messaging gateway carries out to process an incoming email from the network.

FIG. 6a is a flowchart illustrating the process a messaging gateway carries out to add payment statistics to an incoming question email.

FIG. 7 is a diagram illustrating the preferred structure for a database record that contains a payment instruction.

FIG. 8 is a flowchart illustrating the process a recipient carries out in deciding whether to answer, refuse, ignore, or forward a question email.

FIG. 8a is a flowchart illustrating the process a recipient and his mail user agent undergo in answering an email.

FIG. 8b is a flowchart illustrating the process a recipient and his mail user agent undergo in refusing an email.

FIG. 8c is a flowchart illustrating the process a recipient and his mail user agent undergo in forwarding an email.

FIG. 10 is a flowchart illustrating the process a sender carries out in evaluating a reply to a question email.

FIG. 12 is a flowchart illustrating the process a messaging gateway carries out in logging payments.

FIG. 32a illustrates the preferred format for an outgoing child question email before processing by the sender's messaging gateway.

FIG. 32b illustrates the preferred format for an outgoing child question email after processing by the sender's messaging gateway.

FIG. 32c illustrates the preferred format for a child answer email.

FIG. 32d illustrates the preferred format for a generated parent answer email.

FIG. 34 is a flowchart illustrating the process a messaging gateway carries out, in an alternative embodiment, to process an outgoing email from the mail user agent.

FIG. 34a is a flowchart illustrating the process a messaging gateway carries out, in an alternative embodiment, to process an outgoing email without a demand price.

FIG. 36 is a flowchart illustrating the process a messaging gateway carries out, in an alternative embodiment, to process an incoming email from the network.

FIG. 36a is a flowchart illustrating the process a messaging gateway carries out to generate a parent answer email.

FIG. 37a is a diagram illustrating the preferred structure for a database record that maps a child question email to its parent question email and its offer price.

FIG. 37b is a diagram illustrating the preferred structure for a database record that maps a parent question email to a child answer payment demand.

FIG. 38 is a flowchart illustrating the process a recipient carries out in deciding how to respond to an email: answer; refuse; ignore; forward; or forward with automatic answer forwarding enabled.

FIG. 38a is a flowchart illustrating the process a recipient carries out in forwarding an email that enables automatic forwarding of an answer.

FIG. 42 is a flowchart illustrating the process a messaging gateway carries out in logging and initiating payments.

FIG. 56 is a flowchart illustrating the process a messaging gateway carries out to determine whether to add, to an inbound email, links to relevant previous emails.

### LIST OF REFERENCE NUMERALS

100 Sender's computer

120 User interface on sender's computer

130 Mail user agent on sender's computer

140 Server used by sender

160 Database on server used by sender

170 Messaging gateway on server used by sender

200 Recipient's computer

220 User interface on recipient's computer

230 Mail user agent on recipient's computer

240 Server used by recipient

260 Database on server used by recipient

270 Messaging gateway on server used by recipient

300 Network

471 Send mail software in messaging gateway

472 Receive mail software in messaging gateway

473 Database interface software in messaging gateway

474 Payment system interface software in messaging gateway

500 Payment System

600 Question email generated by sender

601 From address in question email

603 Message-ID message identifier of question email

605 Offer price in question email

608 Text of question

609 Payment statistics for sender and recipient

610 Answer email

611 From address in answer email

613 Message-ID message identifier of answer email

614 In-Reply-To message identifier in answer email

615 Demand price

617 Payment demand in answer email

618 Text of answer

620 Refusal email

623 Message-ID message identifier of refusal email

624 In-Reply-To message identifier in refusal email

628 Text of refusal

630 Forward email

632 To address in forward email

633 Message-ID message identifier in forward email

635 Offer price in forward email

638 Text of forward question

640 Child question email, enabling automatic forwarding of an answer

642 To address in child question email

643 Message-ID message identifier of child question email

644 In-Reply-To message identifier of child question email

645 Offer price in child question email

650 Child answer email

654 In-Reply-To message identifier of child answer email

657 Payment demand in child answer email

658 Text of answer in child answer email

660 Generated parent answer email

662 To address of parent answer email

663 Message-ID message identifier of parent answer email

664 In-Reply-To message identifier of parent answer email

667 Payment demand in parent answer email

668 Text of answer in parent answer email

700 Database record that maps a Message-ID message identifier to a status and a message

702 Message-ID message identifier field

704 Status field

706 Message field

710 Database record that maps a child question message to a parent question message and the child question message offer price

712 Message-ID message identifier of child question message field

714 Message-ID message identifier of parent question message field

716 Offer price of child question message

720 Database record that holds a payment instruction

722 Messaging address field

724 Payment instruction field

730 Database record that maps a parent question message to a child answer message payment demand

732 Message-ID message identifier of parent question message field

734 Payment demand of child answer message field

### DETAILED DESCRIPTION OF INVENTION

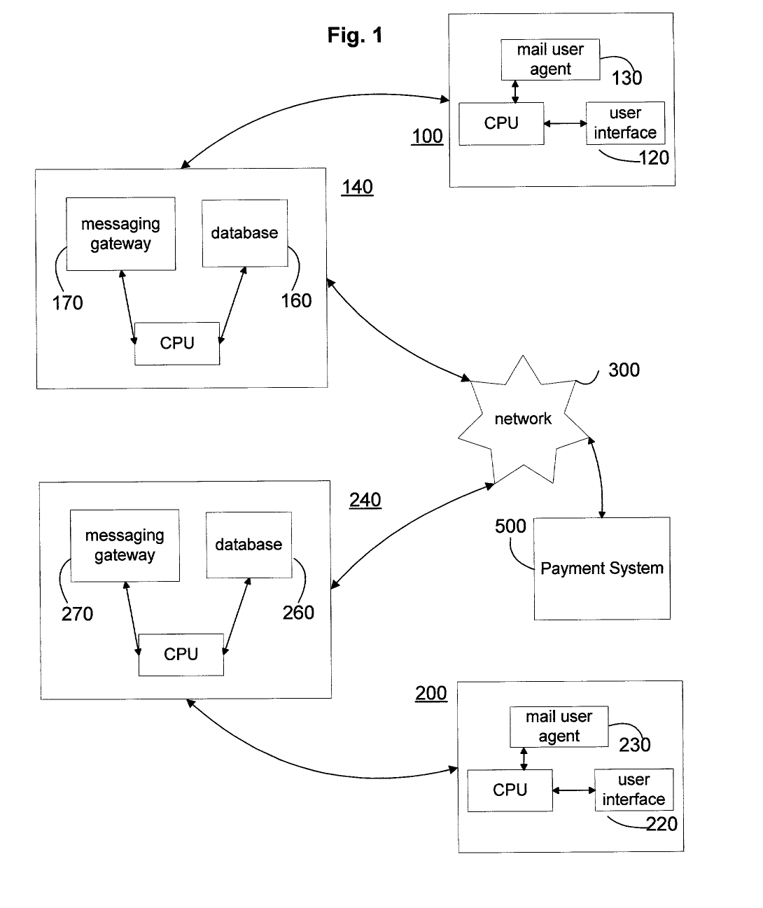

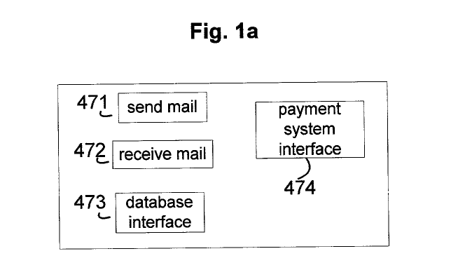

FIG. 1 is an overview of the computer system for practicing the preferred embodiment of the messaging gateway: using the messaging gateway as a question-and-answer service. The computer system includes a sender's computer 100, a server 140 used by the sender, a recipient's computer 200, a server 240 used by the recipient, a network 300, and a payment system 500.

Sender's computer 100 contains a conventional CPU, a user interface 120, and a mail user agent 130. Computer 100 may be any computing device such as a desktop computer, a laptop, a handheld wireless mechanism, or a cellular phone. User interface 120 may be any available user interface. Mail user agent 130 may be any mail user agent software that can generate conventional “forward,” “reply,” and “new” messages.

Sender's server 140 contains a conventional CPU, a database 160, and a messaging gateway 170. The database may be any available database.

Messaging gateway 170 includes a send mail routine 471, a receive mail routine 472, a database interface 473, and a payment system interface 474.

Payment system 500 may be any payment system that has the following features. The payment system must be able to accept and fulfill a message requesting that a payment be made to an account. Additionally, the payment system must send a notification message when the account has received a payment. The payment system may be integrated into the messaging gateway or it may be external, third-party software. The implementation of payment system interface 130 will vary depending upon which payment system, or combination of payment systems, is utilized.

Recipient's computer 200 corresponds directly to sender's computer 100, having all of the same elements. Accordingly, recipient's computer 200 contains a conventional CPU, a user interface 220, and a mail user agent 230.

Recipient's server 240 corresponds directly to sender's server 140, having all of the same elements. Accordingly, recipient's server 240 contains a conventional CPU, a database 260, and a messaging gateway 270.

Messaging gateway 270 includes a send mail routine 471, a receive mail routine 472, a database interface 473, and a payment system interface 474.

Sender's computer 100, recipient's computer 200, sender's server 140, and recipient's server 240 may all contain additional components not shown in FIG. 1. For example, each computer typically includes some combination of the following components: a video display device; an input device, such as a keyboard, mouse, or pointing device; a CD-ROM or DVD drive; a permanent storage device, such as a disk drive. Additionally, the system may contain any number of sender's computers 100, sender's servers 140, recipient's computers 200, and recipient's servers 240.

In an alternative embodiment, the mail user agent and messaging gateway are merged together. The resulting software can reside on the user's machine or on a server machine to which the user logs in. The descriptions of the preferred and other alternative embodiments' operations still apply if this alternative embodiment is implemented. Whether the messaging gateway and mail user agent are one or two pieces of software does not change how the system functions.

In another alternative embodiment, many users may access a server, sharing a messaging gateway and a database. A one-to-one user-to-server relationship is not necessary for the system to function as described.

Operation of Invention

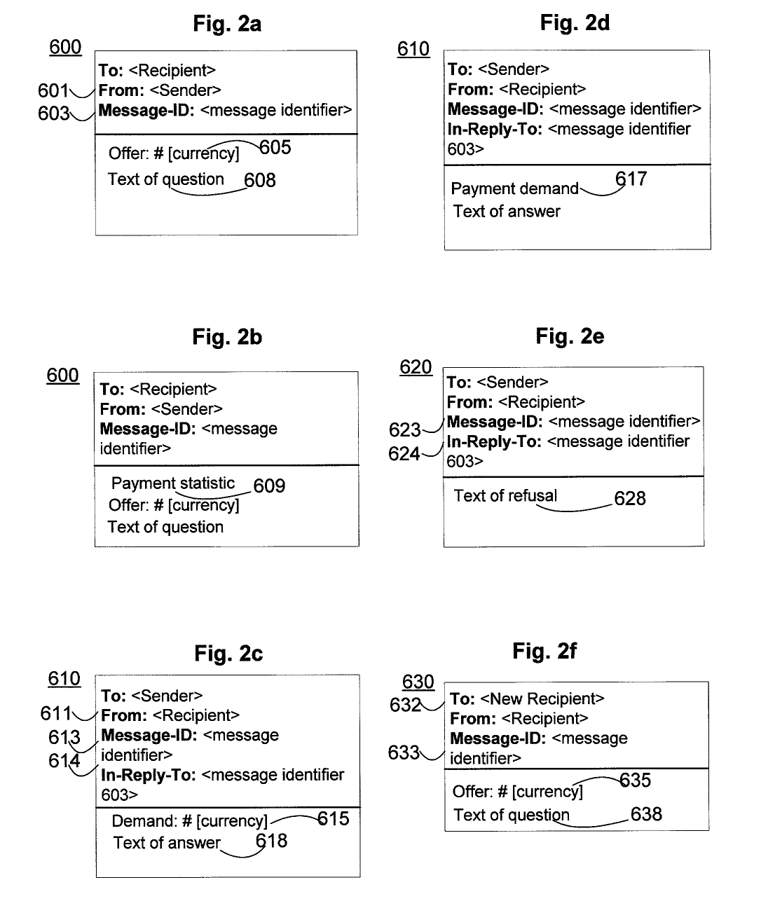

Send Out Question—FIGS. 2a, 3, 4

A sender generally enters the network by sending a question through a messaging gateway account. In the preferred embodiment, the account is email-based. However, the invention is not limited to using email as the message delivery mechanism. Any message delivery mechanism can be used.

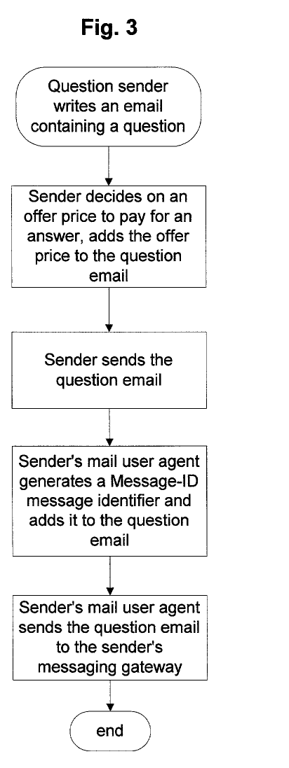

FIG. 3 is a flowchart illustrating the process of creating and sending a question email. The sender writes a question email 600 (FIG. 2a) that contains a question 608. He decides on an offer price 605 that he will pay for an answer. He adds offer price 605 to email 600.

The messaging gateway recognizes two types of prices: an offer price and a demand price. The offer price is used by a question sender to indicate the amount he or she will pay for an answer. The demand price is used by an answerer to indicate to the messaging gateway that payment for the email is expected. In this implementation, offer prices are preceded by the word “offer” while demand prices are preceded by “demand.” However, offer and demand prices may be differentiated in any other way, as long as the differentiation is consistent throughout the implementation. They may also appear anywhere in the email, although the figures show them in the first line in the body of the email.

Referring still to FIG. 3, the sender uses a “send mail” command in mail user agent 130 to send email 600. Mail user agent 130 generates a unique Message-ID message identifier 603. Both the send mail command and the message identifier generation are conventional elements of mail user agents. The mail user agent adds Message-ID message identifier 603 to email 600. Mail user agent 130 sends email 600 to messaging gateway 170.

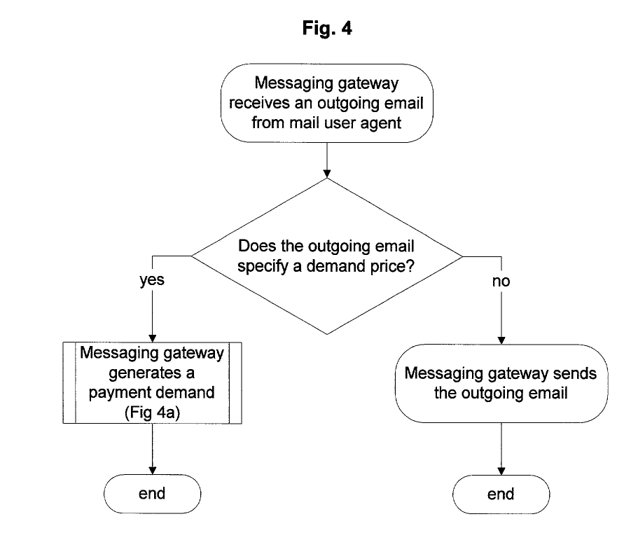

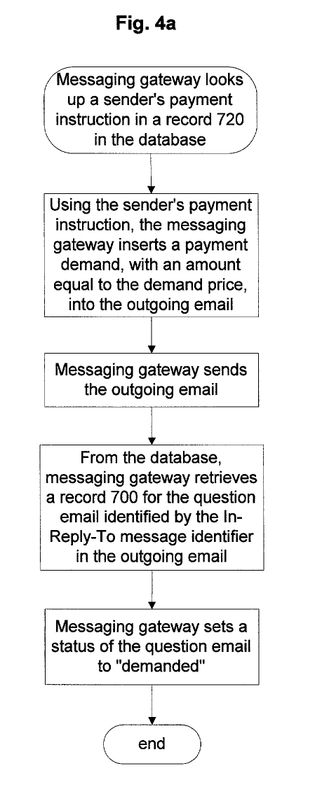

Messaging gateways use the offer-demand price differentiation to determine whether to add information to a given email. For instance, an outgoing email with a demand price requires the addition of a payment demand. An incoming email with an offer price requires the addition of payment statistics. Email 600, an outgoing email with an offer price, requires no special treatment, as demonstrated in FIG. 4.

FIG. 4 is a flowchart illustrating how a messaging gateway processes an outgoing email from the mail user agent. Messaging gateway 170 receives outgoing email 600 from mail user agent 130. Messaging gateway 170 checks email 600 for a demand price. The messaging gateway does not find a demand price. Messaging gateway 170 sends email 600.

Receive Question—FIGS. 2b, 5, 6, 6a, 8

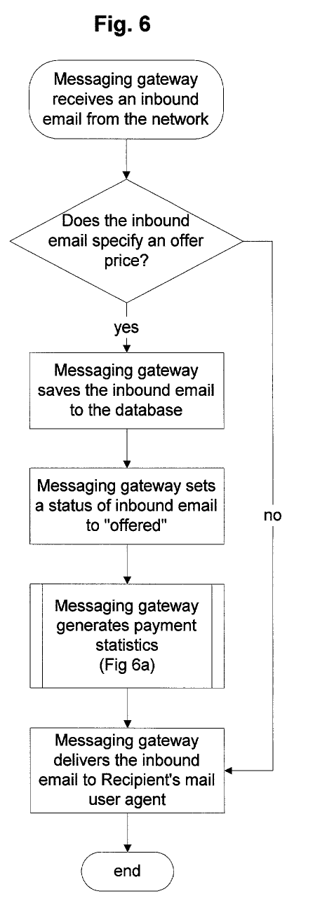

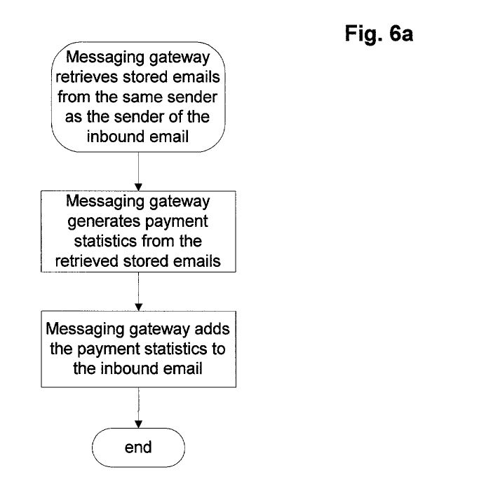

FIG. 6 is a flowchart illustrating the process a messaging gateway carries out in processing an incoming email from network 300. Messaging gateway 270 cannot assume that every incoming email is a question email. For instance, the incoming email might be a request for clarification regarding a question email. To this end, the messaging gateway checks for an offer price in the email. If the offer price exists, then the email is a question and must undergo further processing. If no offer price is present, the unchanged email is delivered to the mail user agent. Email 600 has offer price 605, so the messaging gateway saves email 600 to database 260.

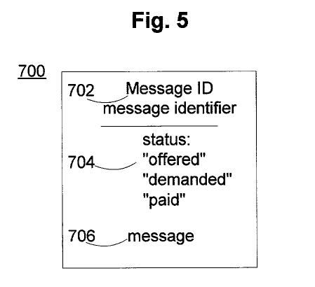

FIG. 5 shows the preferred structure of a database record 700. A database contains many instances of record 700. Record 700 maps a Message-ID message identifier field 702 to a status field 704 and a copy of the message field 706. To store message 600 in record 700, database 260 stores Message-ID message identifier 603 in field 702. Database 260 saves the entire message 600 to field 706. Field 704 contains the current status of email 600, set to “offered.”

The message may be stored in ways not shown in FIG. 5. For example, a record may only keep the necessary elements, the offer price and a From address 601, of message 600, and not save the entire message. FIG. 5 demonstrates the simplest way to save the needed information.

Referring again to FIG. 6, Messaging gateway 270 will generate and add payment statistics to email 600.

Messaging gateways calculate payment statistics. Payment statistics are kept on every transaction and added to every inbound question email. Payment statistics generally include:

the number of questions sent by a sender to a recipient;

the number of these questions the recipient has answered;

how often the sender pays for answers.

Payment statistics assist users in assessing the likelihood of payment when forwarding or answering a question from a given sender.

Messaging gateways use stored messages and status indicators to calculate payment statistics. Each messaging gateway saves incoming emails that contain an offer price. Each database record contains status field 704 which denotes the email's status. The status is either

“offered,” if the question has been received but not answered,

“demanded,” if the question has been answered,

“paid,” if payment was received for an answer to the question.

The basic mechanism for calculating payment statistics is comparing the number of “demanded” emails to the number of “paid” emails, but other comparisons may also be helpful.

FIG. 6a is a flowchart illustrating how a messaging gateway generates payment statistics and adds them to a question email. Messaging gateway 270 calculates a plurality of payment statistics 609 using all stored emails from the sender of email 600. Messaging gateway 270 generates the payment statistics from these stored emails, as just discussed. Payment statistics 609 are added to email 600 (FIG. 2b).

Referring again to FIG. 6, Messaging gateway 270 delivers email 600 to the recipient's mail user agent.

In an alternative embodiment, payment statistics are not calculated on demand. Instead, a running total of each payment statistic is kept and updated as new information is obtained. When payment statistics are required, the totals are retrieved from the database.

In another alternative embodiment, payment statistics 609 are not added to email 600. Instead, the payment statistics are displayed on another medium which the recipient can access, such as a web page. Messaging gateway 270 adds directions for accessing the medium to email 600. For example, the messaging gateway might add a URL to email 600.

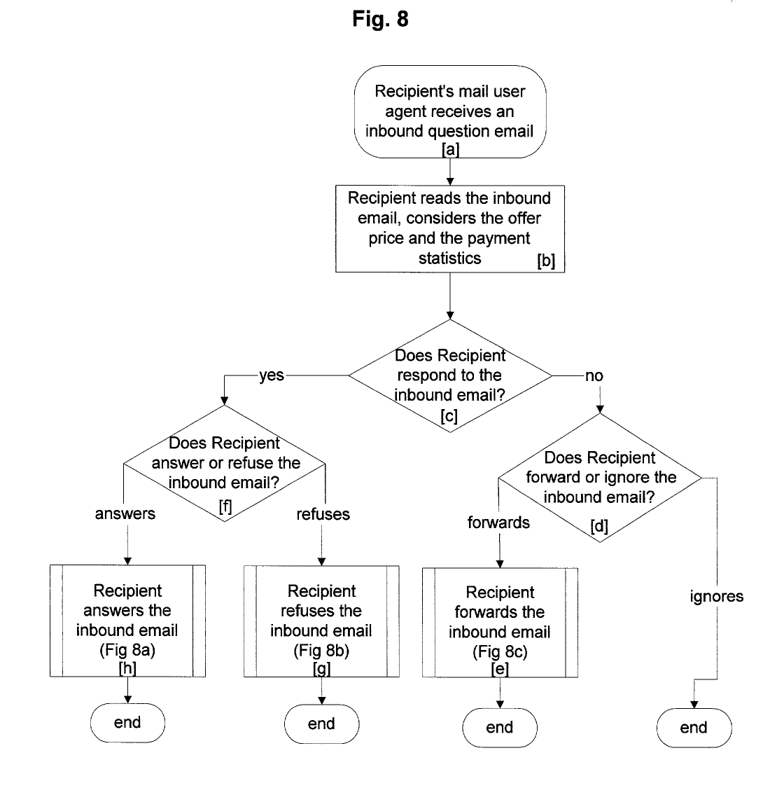

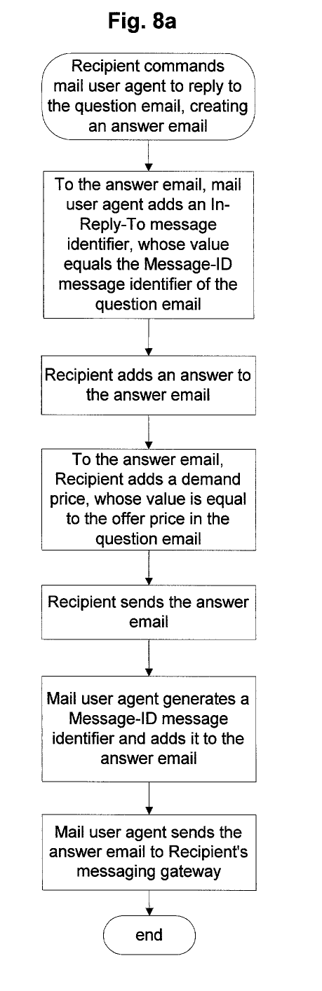

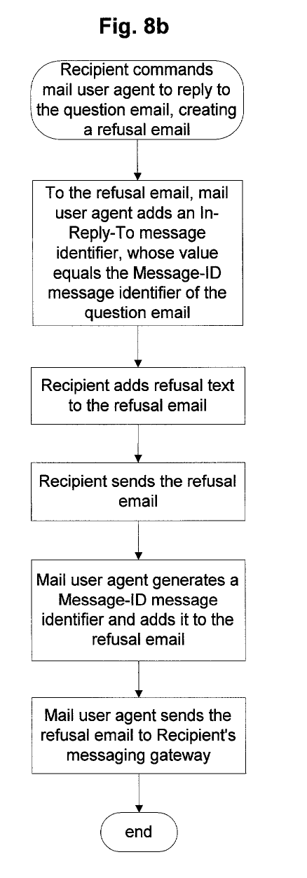

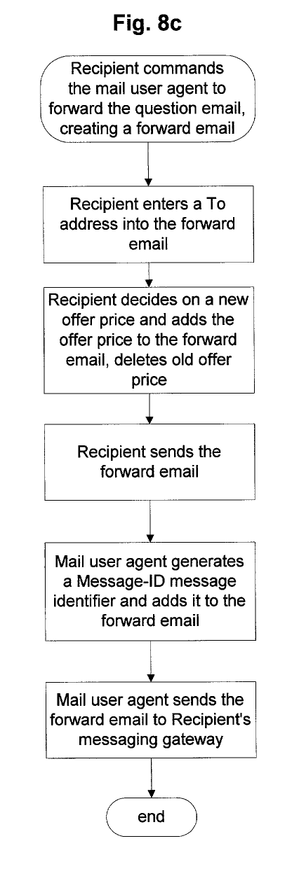

FIG. 8 is a flowchart illustrating the recipient's action choices as to an incoming question email: answer; refuse; forward; or ignore. This description will follow the first three choices through to the end of the question-answer cycle. For each of these scenarios, discussion begins at step c of FIG. 8, in which the recipient decides whether to respond. If a recipient ignores a message, then the question-and-answer cycle is over immediately.

The recipient's mail user agent 230 receives email 600 from messaging gateway 270. The recipient reads the question in email 600 and considers offer price 605 and payment statistics 609. If offer price 605 makes answering worthwhile, the recipient may answer question 608 in email 600. However, the recipient must also weigh payment statistics 609. The payment statistics should favor payment by the sender or the recipient will ignore or refuse the question. In the scenario discussed first, the recipient chooses to answer the email.

Answer Question—FIGS. 2c, 2d, 4, 4a, 7, 8a

FIG. 8a is a flowchart illustrating the process the recipient follows when answering email 600. The recipient commands mail user agent 230 to create a reply to the question email, creating an answer email 610 (FIG. 2c). To email 610, mail user agent 230 adds an In-Reply-To message identifier 614. The value of In-Reply-To message identifier 614 is equal to Message-ID message identifier 603. The In-Reply-To message identifier is used by the messaging gateways to retrieve the question email to which an answer replies. Adding an In-Reply-To message identifier is conventional behavior for mail user agents.

The recipient types an answer 618 into email 610. The recipient must notify messaging gateway 270 that the email is an answer and should contain a payment demand. To signal this, the recipient adds a demand price 615 to reply email 610. Demand price 615 is equal to offer price 605. When messaging gateway 270 processes email 610, it will check email 610 for a demand price. Upon finding demand price 615, the messaging gateway will add a payment demand 617. The payment demand is discussed in more detail below. The recipient sends email 610. Mail user agent 230 generates a Message-ID message identifier 613. The mail user agent adds Message-ID message identifier 613 to email 610. Mail user agent 230 sends email 610 to messaging gateway 270.

Again referring to FIG. 4, messaging gateway 270 receives outgoing email 610. Messaging gateway 270 notes that email 610 specifies a demand price. The messaging gateway determines that email 610 requires the addition of a payment demand.

FIG. 4a is a flowchart illustrating how a messaging gateway generates and adds the payment demand to an email. FIG. 4a refers to the “sender” of a message. The recipient of email 600 is the sender of email 610. In FIG. 4a, he is referred to as the “sender” because he is sending email 610. Using From address 611, messaging gateway 270 looks up the sender's payment instruction in database 260.

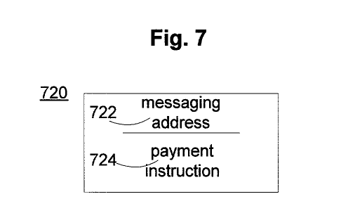

FIG. 7 is a diagram which illustrates the preferred structure of a database record that holds a payment instruction. A payment instruction record 720 maps a messaging address field 722 to a payment instruction field 724. A payment instruction is comprised of account information, such as an account number. The payment instruction is collected when a member opens an account with the question-and-answer service. The payment system used will dictate the specific information held in field 724. FIG. 7 demonstrates the most basic way of storing this information, but the information may be stored in many different ways.

Referring again to FIG. 4a, the messaging gateway uses the payment instruction from field 724 and demand price 615 to build payment demand 617. Messaging gateway 270 adds Message-ID message identifier 603 to the payment demand. Messaging gateway 270 adds the payment demand to email 610 (FIG. 2d).

Payment demands can take numerous forms, such as a link to a web page. The web page might have a form that allows the payer to easily deposit into the answer sender's payment account. Payment demands must give the payer enough information to initiate the payment; a demand price 615, account information, and question email Message-ID message identifier 603 are included in payment demand 617. Exact details of the payment demand depend on which payment system 500 is being used.

Referring again to FIG. 4a, messaging gateway 270 sends email 610. Messaging gateway 270 uses In-Reply-To message identifier 614, which holds the Message-ID message identifier of email 600, to retrieve the corresponding record 700 from database 260. The messaging gateway sets status field 704 to “demanded.”

Receive a Reply—FIGS. 6, 10, 12

Referring again to FIG. 6, messaging gateway 170 receives email 610 from network 300. Messaging gateway 170 checks whether email 610 specifies an offer price. Since no offer price is present, messaging gateway 170 delivers email 610 to mail user agent 130.

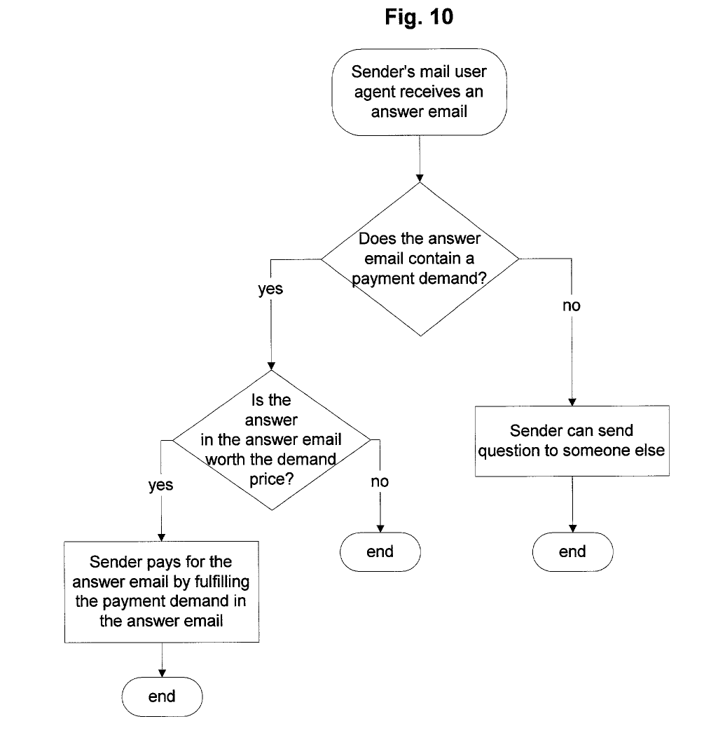

FIG. 10 is a flowchart illustrating the question sender's decision process when he receives a reply to his question. The sender of question email 600 receives email 610 in mail user agent 130. From the presence of payment demand 617, the sender of email 600 knows that email 610 is an answer, not a refusal. He reads answer 618 in email 610 and determines whether the answer is worth demand price 615. If it is not, the sender of email 600 does nothing. If the sender of email 600 does not pay, his neglect will be apparent to the sender of email 610. In the sender of email 610's database 260, email 600 is marked as “demanded” and waiting for payment. The non-payment will be reflected in the payment statistics that the sender of email 610 sees when the sender of email 600 next messages him. By not paying, the sender of email 600 would damage his relationship with the sender of email 610.

Should the sender of email 600 decide to pay, he fulfills payment demand 617, following the instructions given in the payment demand. How fulfillment occurs depends upon which payment system 500 is used.

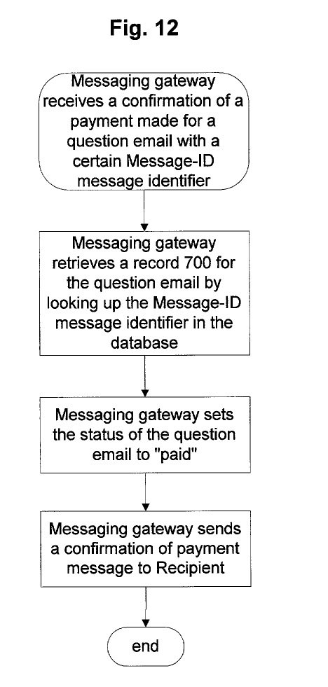

FIG. 12 is a flowchart illustrating the process a messaging gateway executes to log payments. Messaging gateway 270 receives confirmation of a payment made in conformance with payment demand 617. The confirmation includes question email 600's Message-ID message identifier 603. The messaging gateway retrieves the corresponding record 700 from database 260 using Message-ID message identifier 603. The messaging gateway sets status 704 to “paid.” Messaging gateway 270 sends a notification to the sender of answer email 610, informing him that he was paid. The question-answer cycle is complete.

Refuse Question—FIGS. 2e, 4, 8b

Instead of answering the question email the recipient may choose to refuse it. He will refuse it if

he cannot answer it and does not know anybody who can;

the offer price is too low;

the sender's payment statistics do not favor payment. Referring back to FIG. 8 step c, the recipient makes the choice to reply to email 600 with a refusal.

FIG. 8b is a flowchart illustrating the process the recipient follows to refuse a question. He commands mail user agent 230 to create a reply to question email 600, creating a refusal email 620 (FIG. 2e). Mail user agent 230 adds an In-Reply-To message identifier 624 containing Message-ID message identifier 603 from email 600. The recipient adds a refusal message 628 to the body of email 620. He sends email 620. Mail user agent 230 generates a Message-ID message identifier 623 ands adds it to email 620. Mail user agent 230 sends email 620 to messaging gateway 270.

Referring back to FIG. 4, messaging gateway 270 receives outgoing email 620. Messaging gateway 270 checks for a demand price, which does not exist in email 620. The messaging gateway sends email 620.

Receive a Refusal—FIGS. 6, 10

Referring back to FIG. 6, messaging gateway 170 receives email 620. Messaging gateway 170 determines that email 620 does not specify an offer price. The messaging gateway delivers email 620 to mail user agent 130.

Referring back to FIG. 10, the sender reads email 620. He sees that email 620 does not contain a payment demand; the email is a refusal. The sender can ask his question of other network members if he wishes. He might reevaluate the question and the price he offered. Perhaps the question was not clear or the price too low. The question-answer cycle is complete.

Forward Question—FIGS. 2f, 8, 8c, 10, 12

Returning to FIG. 8 step c, the recipient decides to forward email 600. A recipient will forward an email if he cannot answer it and he knows someone who might be able to. Before forwarding the email, the recipient will still consider offer price 605 and payment statistics 609. If these favor an acceptable payment, then the recipient will feel comfortable forwarding the email to someone he knows.

FIG. 8c is a flowchart illustrating the process by which a user forwards a message. The recipient commands his mail user agent 230 to create a forward email 630 (FIG. 2f). Email 630 contains a copy 638 of question 608. The recipient types a To address 632 into email 630. The recipient decides on an offer price 635 that he will pay for the answer to email 630. If offer price 635 is lower than offer price 605, then the recipient may receive a finder's fee equal to offer price 605 minus offer price 635. The recipient deletes offer price 605 from email 630 and adds offer price 635. The recipient sends email 630.

The recipient needs to remember that email 630 is a forward of email 600. When he receives a reply to email 630, he will need to forward the reply to the sender of email 600. Ideally, mail user agent 230 would have some way to denote relationships between original emails and forwards. Otherwise, the user can just save email 600 and look for it when he receives a reply to message 630. The recipient should also save email 630 so that he can refer back to offer price 635. An alternative embodiment of the messaging gateway, described in the “Alternative Embodiments” section, can automate these tasks.

Referring still to FIG. 8c, mail user agent 230 generates a Message-ID message identifier 633. The mail user agent adds the Message-ID message identifier to email 630. Mail user agent 230 sends email 630 to messaging gateway 270.

When the recipient receives a reply to email 630, he forwards it to the sender of email 600. The forwarded answer has the same elements as email 610, but with different content. The recipient creates a reply to email 600, using the “reply” command in mail user agent 230. He copies an answer text from his version of email 610 to the reply email and sends it.

After the recipient forwards the answer, the cycle continues as previously described. The sender of question email 600 decides whether to pay up (FIG. 10). The sender of email 600 decides to pay for the answer.

Referring back to FIG. 12, the messaging gateway of the recipient of email 600 sends the recipient a notification message; he has been paid for answering email 600. He is now responsible for paying offer price 635 to the recipient of email 630. He looks up the reply to email 630 and fulfills its payment demand.

Alternative Embodiments

New Users

The preferred embodiment addresses the exchange of messages among question-and-answer service members. Sending questions only to other members may not always be possible or desirable, especially as the system is just getting established. In an alternative embodiment, the sender can send a question email to anyone, regardless of the recipient's membership status. The sender himself does not even need to be a member.

A member can send a question email to a non-member. The member prepares an email similar to email 600. To the email, the member adds an explanatory paragraph about the question-and-answer service. The paragraph contains a URL. The URL links to a web page on which the nonmember can sign up with the service. The member sends the email.

If the non-member turns out to be a member, no harm is done. The email is processed normally. Most users will know whether the address they are messaging is a member address or not. However, if the user is unsure, then he should treat the address as a non-member address.

A non-member receiving the email will need to sign up for an account if she wishes to answer the question and receive the offer price. She can simply go to the indicated web page and sign up. She will receive a system email address. When she forwards the question email to the system email address, the question enters the system. The new member can now answer or forward the question and reap the benefits.

A non-member can send a question to a member. When the member receives the question, he will not want to answer it for free. He can create a refusal email similar to email 620. As the refusal text, the member explains the question-and-answer service and provides a link to the sign-up page. The member notes that if the question is resent through the system, with an offer price, then he can answer it or find an answerer.

Referring other people to the question-and-answer service is in each member's best interest. People are more likely to answer questions if they can receive a reward. The member is more likely to get his questions answered through members than non-members.

Automatic Forwarding of Answers

Users may find that keeping track of original emails and forwards is tricky or inconvenient. In an alternative embodiment, the messaging gateway can assist users by keeping track of forwards, generating replies from answers, and automating payments. The messaging gateway automatically generates an email from an answer to a question that was specially forwarded. The original question is called a “parent question” and the forwarded question is called a “child question.” An answer to the child question is called a “child answer.” The answer generated from the child answer is called a “parent answer” because it is an answer to the parent question.

The automatic forwarding of answers feature is useful even when a payment system is not utilized by the messaging gateway. The feature can be used anytime a recipient forwards a message and wishes a reply to be forwarded to the sender of the parent question email. For completeness, this description assumes a payment system.

In this embodiment, the messaging gateway automatically initiates a payment for the child question if it has generated the parent answer. When the messaging gateway receives a payment for the parent question, it looks in the database to determine whether it generated the corresponding parent answer. If so, it initiates a payment for the child question.

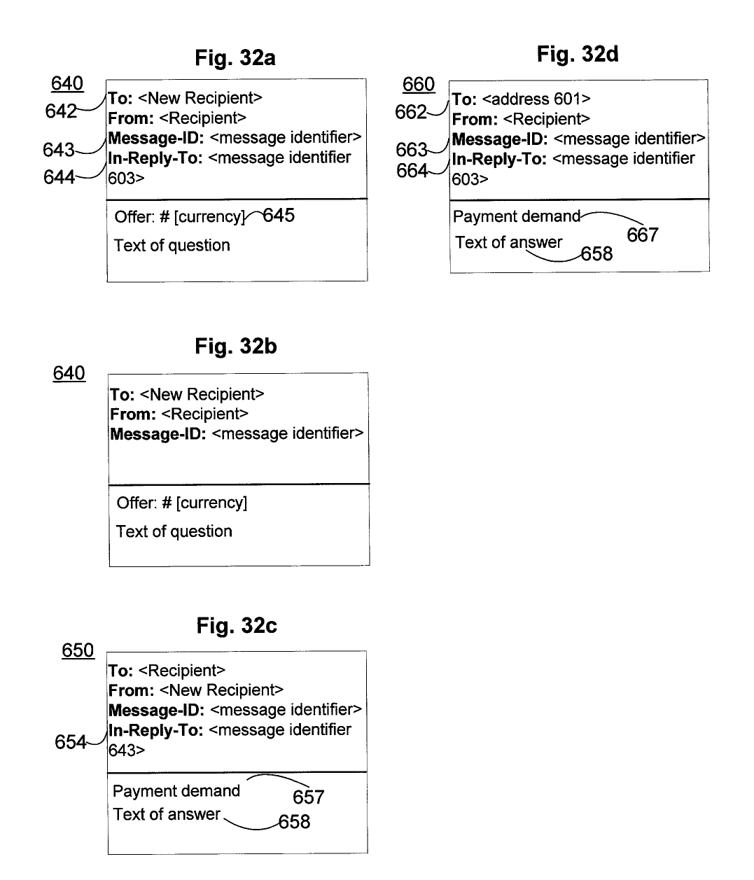

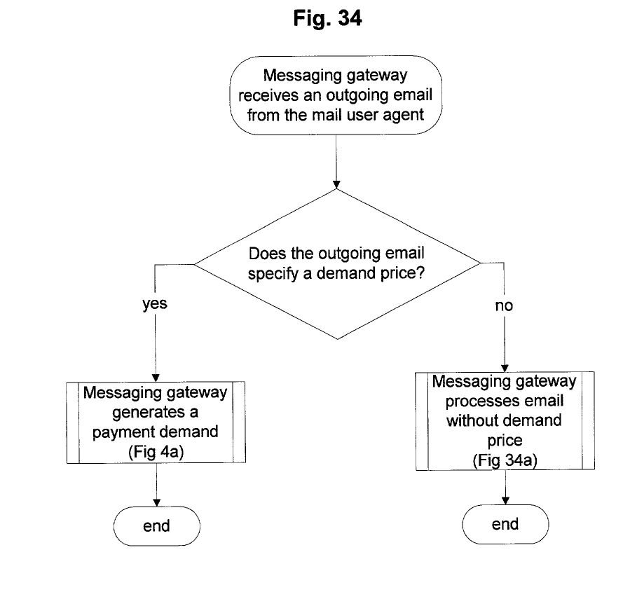

For example, as in the preferred embodiment, the recipient receives email 600. Email 600 is the parent question email. The recipient forwards parent question email 600 to create a child question email 640 (FIG. 32a). Eventually, messaging gateway 270 receives a child answer email 650 (FIG. 32c) in answer to child question email 640. The messaging gateway uses an answer 658 in child answer email 650 to generate a new answer message, parent answer email 660 (FIG. 32d). Parent answer email 660 answers parent question email 600. Parent answer email 660 is sent to the sender of parent question email 600. The sender of parent question email 600 pays price 605. Messaging gateway 270 receives a confirmation of the payment. The messaging gateway then sends a portion of this payment to the sender of the child answer email 650. The process is explained in detail below, beginning with the receipt of parent question email 600 by the recipient.

Forward Parent Question Email—FIGS. 32a, 32b, 34, 34a, 37a, 38, 38a

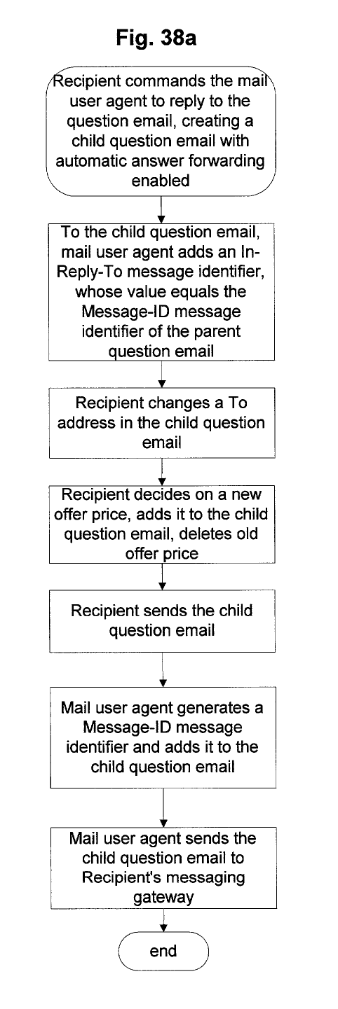

FIG. 38 is a flowchart illustrating the process a recipient carries out in deciding how to respond to an email. FIG. 38 is very similar to FIG. 8 except the recipient must now make an additional choice (step e) when deciding whether to forward an email. He must decide whether he wants to edit child answer email 650 or whether he wants the messaging gateway to automatically generate a parent answer. If the messaging gateway generates an answer, it will also handle paying the sender of child answer email 650. While allowing the messaging gateway to handle the answer is easier, the recipient may wish to see an answer and manually forward it (as explained in the preferred embodiment).

The choice the recipient makes depends on many factors. For instance, he may be a translator. Perhaps parent question email 600 is written in Russian, but the possible answerer only speaks English. The recipient would need to translate parent question email 600 to English and child answer 650 to Russian. Or perhaps the possible answerer is very knowledgeable but a horrible writer. The recipient may wish to edit the response, to be more legible, before passing it on to the parent question sender. He wants the answer to be as good as possible so that the sender of parent question email 600 will pay price 605. If the price is paid, he will receive his finder's fee and maintain good relationships with the sender of child answer email 650.

In this case, the recipient decides that he will not need to edit an answer email. He chooses to forward parent question email 600 using the method that enables automatic answer forwarding.

FIG. 38a is a flowchart illustrating the process by which a recipient sends a child question email, enabling automatic answer forwarding. The recipient forwards parent question email 600 by using the reply command, instead of the forward command, in mail user agent 230. The mail user agent creates child question email 640 (FIG. 32a). Using the reply command generates an In-Reply-To message identifier 644 in child question email 640. The value of In-Reply-To message identifier 644 is equal to Message-ID message identifier 603 of email 600. When messaging gateway 270 receives child question email 640, it will map the child question email to parent question email 600, using these message identifiers. This mapping will assist the messaging gateway in generating the parent answer email.

The recipient changes a To address 642 to the address of the new recipient. The recipient determines an offer price 645 for the answering of child question email 640. Offer price 645 must be less than or equal to offer price 605; offer price 605 is the maximum that the sender will pay. The recipient places offer price 645 into child question email 640. He deletes offer price 605. The recipient sends the child question email.

Mail user agent 230 generates a Message-ID message identifier 643 and adds it to child question email 640. Mail user agent 230 sends child question email 640 to messaging gateway 270.

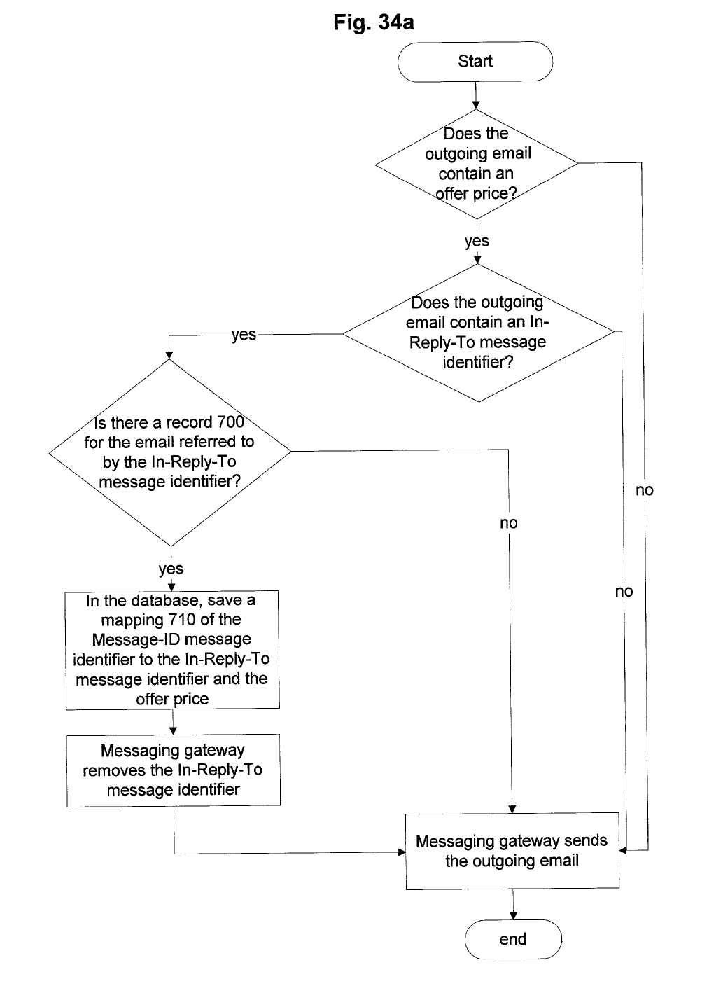

FIG. 34 is a flowchart illustrating the process the messaging gateway executes to determine whether an outgoing message specifies a demand price. FIG. 34 is similar to FIG. 4, but calls a different subprocess for emails that lack a demand price. Messaging gateway 270 receives outgoing child question email 640 from mail user agent 230. Messaging gateway 270 determines that child question email 640 does not contain a demand price.

FIG. 34a is a flowchart illustrating the process used by the messaging gateway to process emails that lack a demand price. Messaging gateway 270 checks child question email 640 for an offer price. Since child question email 640 contains an offer price, the messaging gateway next checks for an In-Reply-To message identifier. The email contains an In-Reply-To message identifier. For the last check, messaging gateway 270 looks in database 260 for a specific record 700. The messaging gateway looks for and finds field 702 in record 700 that contains Message-ID message identifier 603, referred to by In-Reply-To message identifier 644.

The three checks ensure that the outgoing email is a child of a parent question saved in database 260. The presence of an offer price ensures that the outgoing email is a question. The existence of an In-Reply-To message identifier determines that the outgoing email was created with a mail user agent's reply script. The fact that the In-Reply-To message identifier points to a saved question in database 260 shows that the outgoing email has a parent question. If any of these requirements are not met, then the outgoing email is just sent normally. Child question email 640 passes all checks and undergoes further processing.

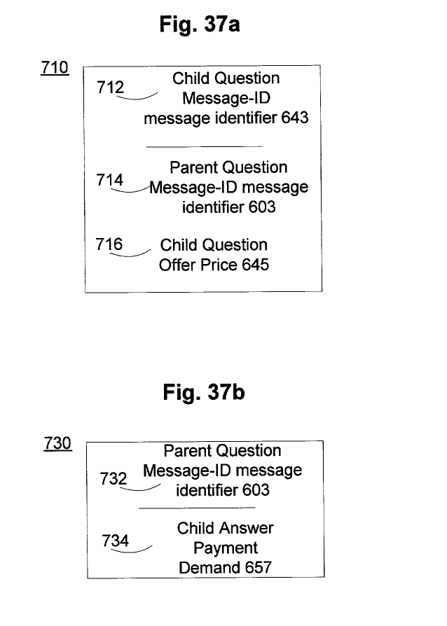

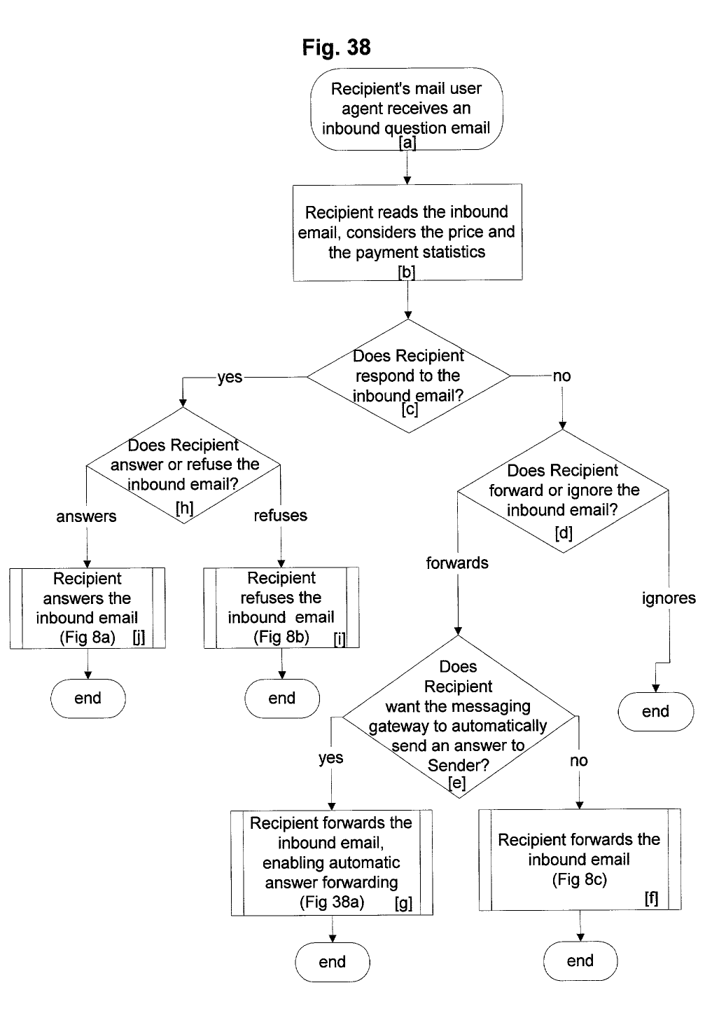

FIG. 37a shows the preferred structure of a database record that maps a child question to a parent question and a child question offer price. When the outgoing email is determined to be a child question email, a mapping 710 is saved. A database will contain multiple instances of mapping 710. Mapping 710 contains a child question Message-ID message identifier field 712 mapped to a parent question Message-ID message identifier field 714 and a child question offer price field 716. Messaging gateway 270 saves Message-ID message identifier 643 to field 712. The messaging gateway saves In-Reply-To message identifier 644, which is equal to the Message-ID message identifier of parent question email 600, to field 714. Messaging gateway 270 saves offer price 645 to field 716.

Before sending child question email 640, messaging gateway 270 removes In-Reply-To message identifier 644 (FIG. 32b). Once the relationship between child question email 640 and parent question email 600 has been saved to record 710, the In-Reply-To message identifier is no longer needed. Messaging gateway 270 sends child question 640.

Send Child Answer Email—FIGS. 32c, 36, 38

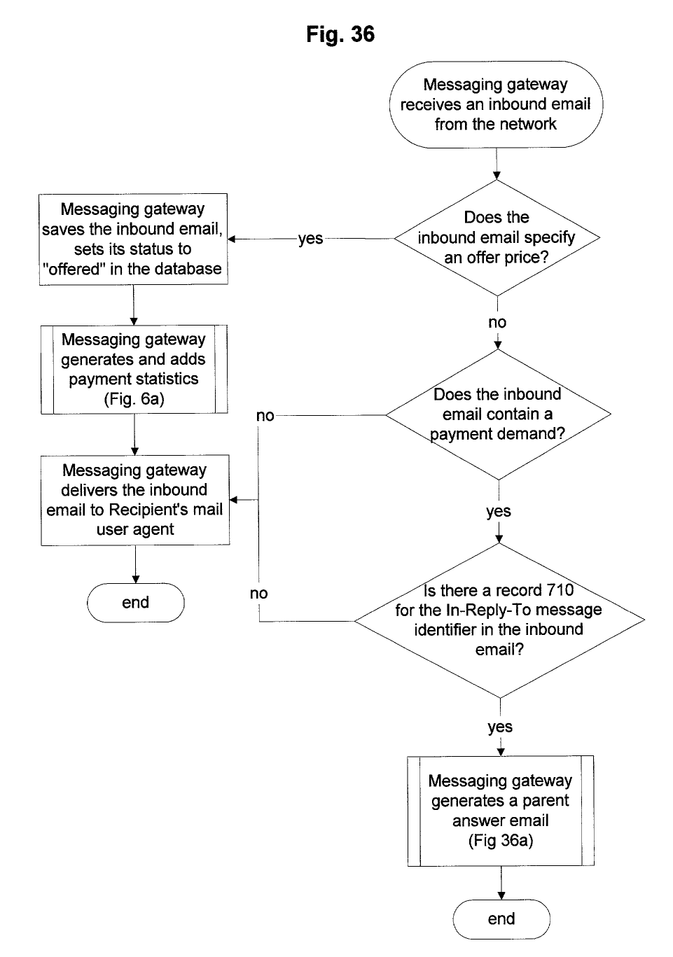

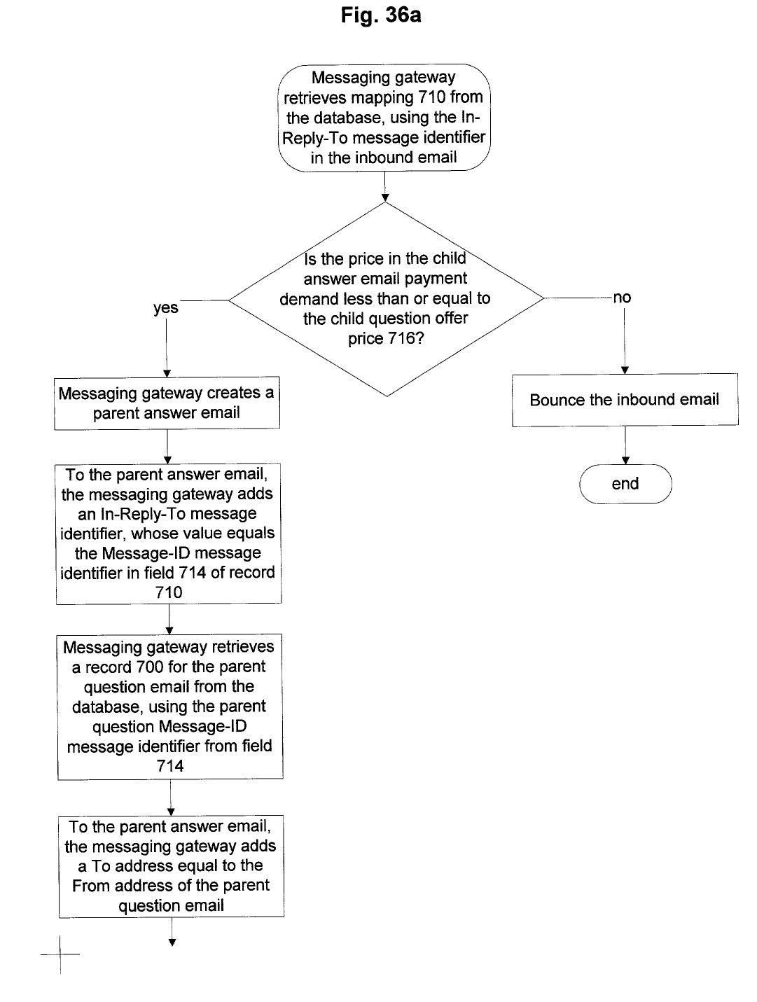

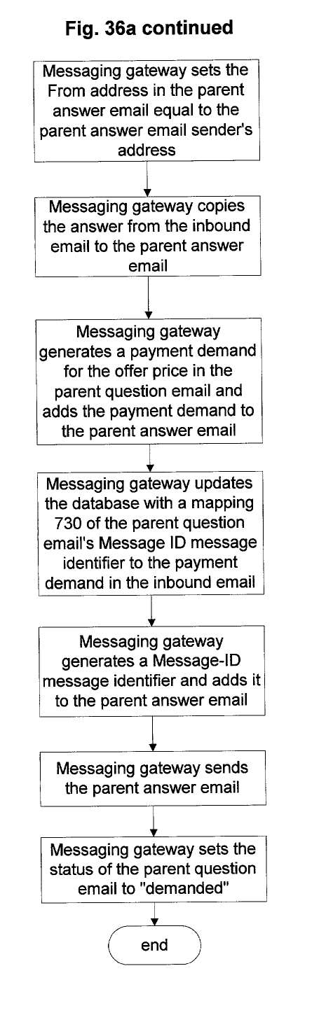

FIG. 36 is a flowchart illustrating how a messaging gateway processes an inbound email from network 300. A messaging gateway used by the recipient of child question email 640 receives the email. The messaging gateway notes that child question email 640 contains an offer price and adds payment statistics. Payment statistics are added in the same manner as in the preferred embodiment (FIG. 6a).

The recipient of email 640 goes through exactly the same process (FIG. 38) that the previous recipient went through with email 600. He has all the same choices: refuse; forward; answer; or ignore. To follow through with the description of an automatically forwarded answer, email 640's recipient answers email 640. The answer process is the same as previously described in the “Answer Question” section, generating an answer email 650 (FIG. 32c). Email 650 is a child answer email, because it is an answer to a child question email. Note that child answer email 650 has an identical structure to answer email 610, although the content differs.

Generate Parent Answer Email—FIGS. 32d, 36, 36a, 37b

Again referring to FIG. 36, messaging gateway 270 receives child answer email 650. The messaging gateway runs several tests to determine how to treat child answer email 650. In the first test, the messaging gateway looks for an offer price. The child answer email does not contain an offer price since it is an answer. In the next test, messaging gateway 270 looks for a payment demand. Child answer email 650 does contain a payment demand. The third test determines whether database 260 contains record 710 for the email indicated by In-Reply-To message identifier 654. In-Reply-To message identifier 654 points to email 640, the child question email. The database does contain record 710 for child question email 640. Through these tests, the messaging gateway determines that an answer email should be generated.

FIG. 36a is a flowchart illustrating how a messaging gateway generates a parent answer email. Before generating an email, the messaging gateway checks that the price demanded in child answer email 650 is a valid amount. Using In-Reply-To message identifier 654, the messaging gateway retrieves mapping 710 from database 260. The price in payment demand 657 cannot be higher than offer price 645 in field 716; the offer price is the maximum that will be paid out. If the price in payment demand 657 passes the test, the parent answer email is generated. If the price fails the test, email 650 is bounced. Bouncing is a standard task performed by messaging gateways. Bouncing means to return an email to its sender. Payment demand 657 passes the test. Messaging gateway 270 generates parent answer email 660 (FIG. 32d), in answer to parent question email 600.

Parent answer email 660 is a reply to parent question email 600, and so must contain an In-Reply-To message identifier. The messaging gateway uses field 714 in mapping 710 to determine the Message-ID message identifier for the parent question email. Message-ID message identifier 603 is stored in field 714. To parent answer email 660, the messaging gateway adds an In-Reply-To message identifier 664, containing Message-ID message identifier 603.

Using Message-ID message identifier 603, the messaging gateway retrieves record 700 for parent question email 600 from database 260. Messaging gateway 270 adds a To address 662 to parent answer email 660. The To address is equal to From address 601 in parent question email 600. The messaging gateway sets a From address in parent answer email 660 to the sender of parent answer email 660's messaging address.

Messaging gateway 270 copies answer text 658 from child answer email 650 to parent answer email 660.

Messaging gateway 270 creates a payment demand 667. The price in payment demand 667 is equal to offer price 605. The messaging gateway looks up the sender of email 660's payment instructions in field 724 of record 720 (FIG. 7) in database 260; the messaging gateway adds them to payment demand 667. The messaging gateway adds Message-ID message identifier 603 to payment demand 667. Messaging gateway 270 adds payment demand 667 to parent answer email 660.

When messaging gateway 270 receives a payment for parent answer email 660, it will need to pay the sender of child answer email 650. FIG. 37b illustrates the preferred structure of a database record that maps a parent question email to a child answer email payment demand. The messaging gateway creates a mapping 730 in database 260. Mapping 730 maps a parent question Message-ID message identifier field 732 to a child answer payment demand field 734. Messaging gateway 270 saves Message-ID message identifier 603 to field 732 and payment demand 657 to field 734. The Message-ID message identifier for email 600 is saved because when a payment is made, the payment system will notify the messaging gateway that a payment was received for question email 600. The messaging gateway can then look up mapping 730 and find the payment demand that it is obligated to fulfill.

Referring again to FIG. 36a, the last step in creating the parent answer email is creating a Message-ID message identifier 663. Messaging gateway 270 adds Message-ID message identifier 663 to parent answer email 660. The messaging gateway sends the parent answer email.

To keep its payment statistics up-to-date, the messaging gateway updates record 700 for parent question email 600. Messaging gateway 270 sets status 704 to “demanded.”

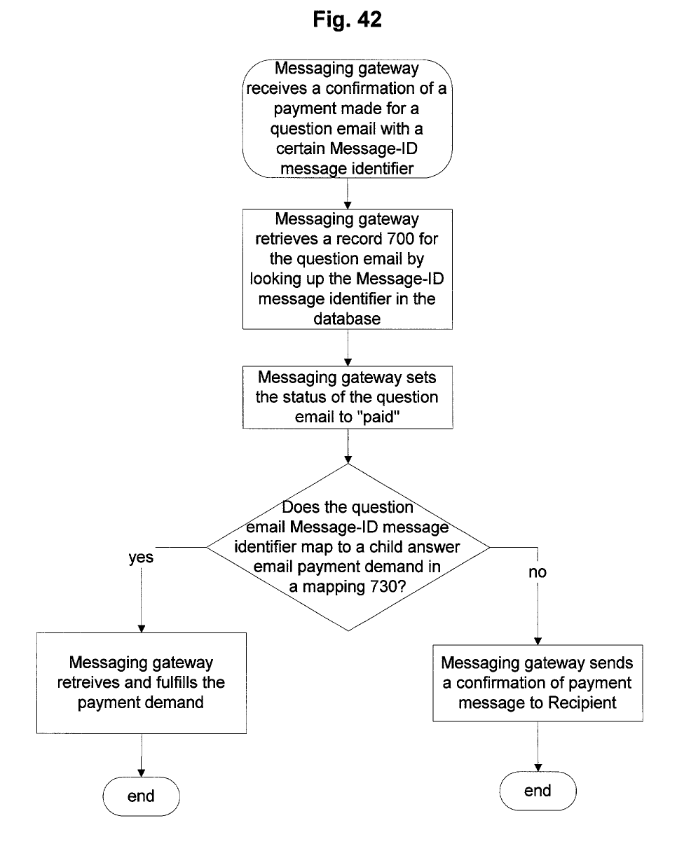

Generate Payment—FIGS. 10, 42

The sender of parent question email 600 receives parent answer email 660 (FIG. 36). The sender decides to fulfill payment demand 667 (FIG. 10).

FIG. 42 is a flowchart illustrating how a messaging gateway receives and distributes payments. Messaging gateway 270 receives a payment notification that the sender of email 600 has paid for an answer to parent question email 600. The messaging gateway retrieves record 700 for Message-ID message identifier 603. Messaging gateway 270 sets status 704 to “paid.”

Messaging gateway 270 searches database 260 for mapping 730 that contains parent question email Message-ID message identifier 603 in field 732. If the mapping is found, then the messaging gateway will initiate a payment. If not, then the messaging gateway sends a confirmation of payment to the recipient of parent question email 600. Mapping 730 does exist in this scenario. Mapping 730 contains child answer payment demand 657. Messaging gateway 270 fulfills payment demand 657. The question-answer cycle is complete.

The examples given in this embodiment and the preferred embodiment describe a message that is forwarded one time and then answered. Of course, the message may be forwarded as many times as necessary to find a recipient who can answer it. Because the process is recursive, the discussion of one forward identifies all processes necessary for any number of forwards to be executed in a question-answer cycle.

The examples given in each embodiment describe emails that are sent to one recipient only. Of course, emails may be sent to as many recipients as desired, however the sender may need to cope with multiple payment demands.

Addition of Information Other than Payment Statistics

In the preferred embodiment, the messaging gateway adds payment statistics to a question email. Payment statistics can only categorize the financial history of the sender and recipient. The recipient's messaging gateway can add all manner of useful information to an inbound email. In an alternative embodiment, the provided information is not limited to transactional histories saved in the internal database. The information can consist of anything that the recipient might find useful: past responses to similar emails or the credit rating of the sender, for instance.

A problem with the automatic forwarding of answers embodiment is that the recipient of email 600, who forwards email 600, never sees the answer. The messaging gateway automatically forwards an answer generated from child answer email 650. If the recipient of email 600 receives a similar question, he has to forward it again; he cannot use the answer that he never read. If messaging gateway 270 saved all answers that it processed, the recipient could answer the repeat questions himself. By answering questions instead of forwarding them, the recipient can garner a larger portion of the offer price.

Messaging gateway 270 can assist the recipient with repeated questions. The messaging gateway populates a knowledge database with all emails it processes. To inbound emails, the messaging gateway adds links, referencing previous emails that are related.

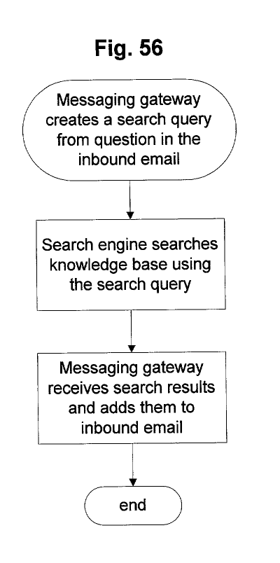

FIG. 56 is a flowchart illustrating the process a messaging gateway carries out to add the links to an inbound email. This process may be added as a sub-process to the messaging gateway's normal inbound email processing as described in FIGS. 6 and 36.

Each time the messaging gateway receives an inbound email, it searches the knowledge database. The messaging gateway can pull keywords out of the question email or generate a natural language query. Existing search engine technology can be used here. The messaging gateway sends the query to the search engine, and the search engine queries the knowledge database. The search returns links to relevant emails in the knowledge database. The messaging gateway adds the links to the inbound email.

Messaging gateway 270 can also search external databases, i.e., databases that are not stored on server 240. For instance, the messaging gateway provides the sender's credit rating. The recipient uses the credit rating to help determine his transaction risk in working with the sender. Messaging gateway 270 searches a credit rating database, run by a third party, for the sender's credit rating. The messaging gateway adds the credit rating to email 600, like it would with payment statistics, and delivers the email to the recipient.

Any relevant information that the messaging gateway can access may be added to inbound emails. The payment statistics, previous emails, credit rating, and any other added information empower the message recipient to better respond to the message and intelligently manage his transaction risk. Links to relevant emails allow the recipient to make efficient use of his knowledge and garner a larger fee.

Conclusion, Ramifications, and Scope

Accordingly, the reader will see that the messaging gateway facilitates collaboration among groups of loosely-related people. The invention encourages users to form new relationship chains that make collaboration easy, efficient, and successful. Finding a collaborator is convenient for users; just send out a message with a collaboration request. Matching a collaborator to this collaboration request happens naturally as a product of users forwarding the message until one can answer it. Users are incentivized to forward and answer messages by the prospect of monetary reward and through social pressures. Each recipient acts as a moderator, sending messages to people who are likely to answer them and not forwarding inappropriate messages. Answers will be of good quality as answerers seek to earn the price offered on a question and to be called upon again for help. Payment statistics allow users to evaluate transaction risk. Each user acts in her own best interest, which is the group's best interest as well.

Other advantages of the messaging gateway invention include:

enabling members to deal only with people they know while benefitting from the involvement of people outside of their social sphere.

enabling in-demand experts to receive messages from a few middlemen. The middlemen act as brokers for a large population of people seeking collaboration from the expert.

enabling members of a chain to learn from experts further up the chain. Next time a similar query comes through, a member lower down the chain can answer it and receive the answer fee.

Although the description above contains many specificities, these should not be construed as limiting the scope of the invention but as merely providing illustrations of some of the presently preferred embodiments of this invention. Many other variations are possible. For example, messages that request collaboration may have deadlines. If a reply is not received by the deadline, the messaging gateway notifies the sender of the lack of replies. The messages could contain a different pricing scheme. For instance, forwarders of a message might get a set portion of the original offer price, instead of being able to set a new offer price. Or the pricing could be done with a bidding system. Any payment system, whether internally integrated or external, may be used to initiate payments. The messaging gateway can be combined with the mail user agent, or they can be separate as described. The messaging gateway works in any kind of network with all sorts of user devices, such as personal digital assistants and cell phones.

Thus the scope of the invention should be determined by the appended claims and their legal equivalents, rather than by the examples given.

We claim:

1. A system for highlighting the relationships between an inbound message and previously processed messages, comprising:
(a) a messaging network,
(b) a database of information collected from a plurality of previously processed messages,
(c) a messaging gateway which will:
(1) examine the inbound message and potentially update said database with information taken from said inbound message,
(2) potentially add a notice to said inbound message which summarizes relevant information contained in said database,
(3) examine an outbound message and potentially update said database with information taken from said outbound message,
whereby a recipient of said inbound message can better formulate a response message to said inbound message.

2. The system of claim 1, wherein said notice links to information in said database.

3. The system of claim 2, wherein said notice links to a selection of said previously processed messages that are determined to have content relevant to the content of said inbound message.

4. The system of claim 1, wherein said notice contains information pulled from a third-party database.

5. The system of claim 1, wherein said messaging gateway may generate a parent answer message based on a child answer message.

6. The system of claim 1, wherein said system utilizes a payment system that can process a payment message and produce a payment confirmation message.

7. The system of claim 6, wherein said messaging gateway may add a payment demand to said outgoing message.

8. The system of claim 6, wherein said messaging gateway may receive said payment confirmation message and update said database to reflect said payment confirmation message.

9. The system of claim 8, wherein said notice includes a payment history of the sender of said inbound message.

10. The system of claim 8, wherein said messaging gateway may initiate a payment for a child answer message in response to a received payment confirmation message for a parent answer message.

11. A method for highlighting the relationships between an inbound message and previously processed messages, comprising:
(a) providing a messaging network,
(b) providing a database of information collected from a plurality of previously processed messages,
(c) providing a messaging gateway which will:
(1) examine the inbound message and potentially update said database with information taken from said inbound message,
(2) potentially add a notice to said inbound message which summarizes relevant information contained in said database,
(3) examine an outbound message and potentially update said database with information taken from said outbound message,
whereby a recipient of said inbound message can better formulate a response message to said inbound message.

12. The method of claim 11, wherein said notice links to information in said database.

13. The method of claim 12, wherein said notice links to a selection of said previously processed messages that are determined to have content relevant to the content of said inbound message.

14. The metnod of claim 11, wherein said notice contains information pulled from a third-party database.

15. The method of claim 11, wherein said messaging gateway may generate a parent answer message based on a child answer message.

16. The method of claim 11, wherein said system utilizes a payment system that can process a payment message and produce a payment confirmation message.

17. The method of claim 16, wherein said messaging gateway may add a payment demand to said outgoing message.

18. The method of claim 16, wherein said messaging gateway may receive said payment confirmation message and update said database to reflect said payment confirmation message.

19. The method of claim 18, wherein said notice includes a payment history of the sender of said inbound message.

20. The method of claim 18, wherein said messaging gateway may initiate a payment for a child answer message in response to a received payment confirmation message for a parent answer message.
